(19) United States
(12) Patent Application Publication
(10) Pub. No.: US 2003/0000555 A1
(43) Pub. Date: Jan. 2, 2003

(54) Circuit board-washing device capable of minimizing detergent residue on circuit boards

(76) Inventor: Jason Ko, Chungli City (TW)

Correspondence Address: Merchant & Gould P.C., P.O. Box 2903, Minneapolis, MN, 55402-0903, US

(21) Appl. No.: 09/897,549

(22) Filed: Jul. 2, 2001

(51) Int. Cl. B08B 3/02

(52) U.S. Cl. 134/122 R; 134/199

(57) ABSTRACT

A circuit board-washing device includes a pair of elongated upper and lower spraying casings located directly over and fixed relative to a tank, which contains a detergent that is forced into the casings. Each of the casings has a chamber and a horizontal wall, which is formed with two longitudinal rows of holes that are in fluid communication with the chamber. The walls of the casings define a washing space therebetween for movement of a horizontal circuit board therethrough in a transverse direction of the casings. The space is slightly wider than the board. The detergent is sprayed from the casings onto the board via the holes, and subsequently falls into the tank for recycle.

### BACKGROUND OF THE INVENTION

1. Field of the Invention

This invention relates to a circuit board-washing device, more particularly to a circuit board-washing device, which can spray a detergent evenly onto the top and bottom surfaces of a horizontal circuit board so as to minimize detergent residue on the circuit board.

2. Description of the Related Art

Referring to FIG. 1, a conventional circuit board-washing device 1 is shown to include a feeding roller unit 11 for feeding a horizontal circuit board 10, a horizontal row of upper nozzles 13, a horizontal row of lower nozzles 14, a pump 15, and a tank 16 for containing a detergent. The roller unit 11 includes a plurality of roller sets, each of which consists of a pair of upper and lower rollers for moving the board 10 therebetween. The detergent is forced by the pump 15 to flow from the tank 16 to the nozzles 13, 14, and is subsequently sprayed onto the top and bottom surfaces of the board 10. Thereafter, the detergent falls from the board 10 into the tank 16 for recycle. Additional detergent will be supplemented automatically into the tank 16 as soon as the detergent level in the tank 16 is lowered to a predetermined level. The aforesaid conventional washing device 1 suffers from the following disadvantages:

The detergent cannot be distributed evenly onto the board 10. For example, the detergent accumulates on the areas of the board 10, to which the nozzles 13, 14 are directed, and cannot easily access other areas of the board 10, which are adjacent to the roller unit 11. As such, after washing, a substantial amount of detergent residue will remain on the top surface of the board 10.

### SUMMARY OF THE INVENTION

An object of this invention is to provide a circuit board-washing device, which can spray a detergent evenly on the top and bottom surfaces of a horizontal circuit board so as to minimize detergent residue on the circuit board.

According to this invention, a circuit board-washing device includes a pair of elongated upper and lower spraying casings located directly over and fixed relative to a tank, which contains a detergent that is forced into the casings. Each of the casings has a chamber and a horizontal wall, which is formed with two longitudinal rows of holes that are in fluid communication with the chamber. The walls of the casings define a washing space therebetween for movement of a horizontal circuit board therethrough in a transverse direction of the casings. The space is slightly wider than the board. The detergent is sprayed from the casings onto the board via the holes, and subsequently falls into the tank for recycle. Each of the holes has a constant detergent flow rate according to the Bernoulli's theorem so that the detergent can be distributed evenly onto the board, thereby minimizing detergent residue on the board.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is a schematic side view of a conventional circuit board-washing device;

FIG. 2 is a schematic side view of the preferred embodiment of a circuit board-washing device according to this invention;

FIG. 3 is a perspective view of an upper spraying casing of the preferred embodiment, illustrating a handle provided on a top surface thereof;

FIG. 4 is a perspective view of the upper spraying casing of the preferred embodiment, illustrating a plurality of guiding teeth and spraying holes formed in a bottom wall thereof; and

FIG. 5 is a schematic view of the preferred embodiment, illustrating the circulation of a detergent.

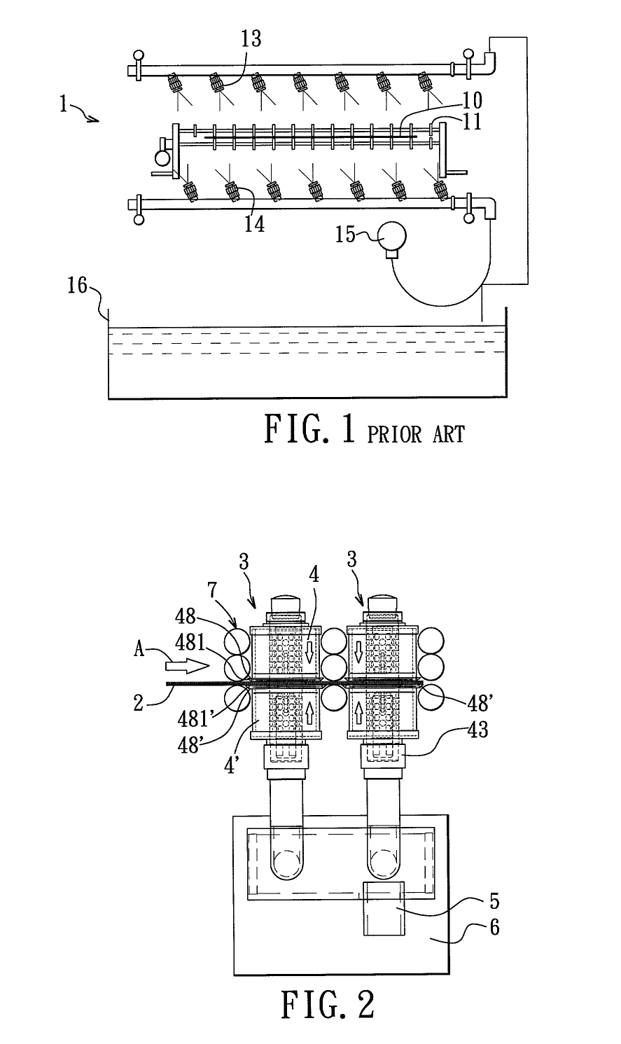

### DETAILED DESCRIPTION OF THE PREFERRED EMBODIMENT

Referring to FIG. 2, the preferred embodiment of a circuit board-washing device of this invention is shown to include two washing units 3 each consisting of a pair of elongated upper and lower spraying casings 4, 4′, a pump 5, a tank 6, and a conveying roller unit 7.

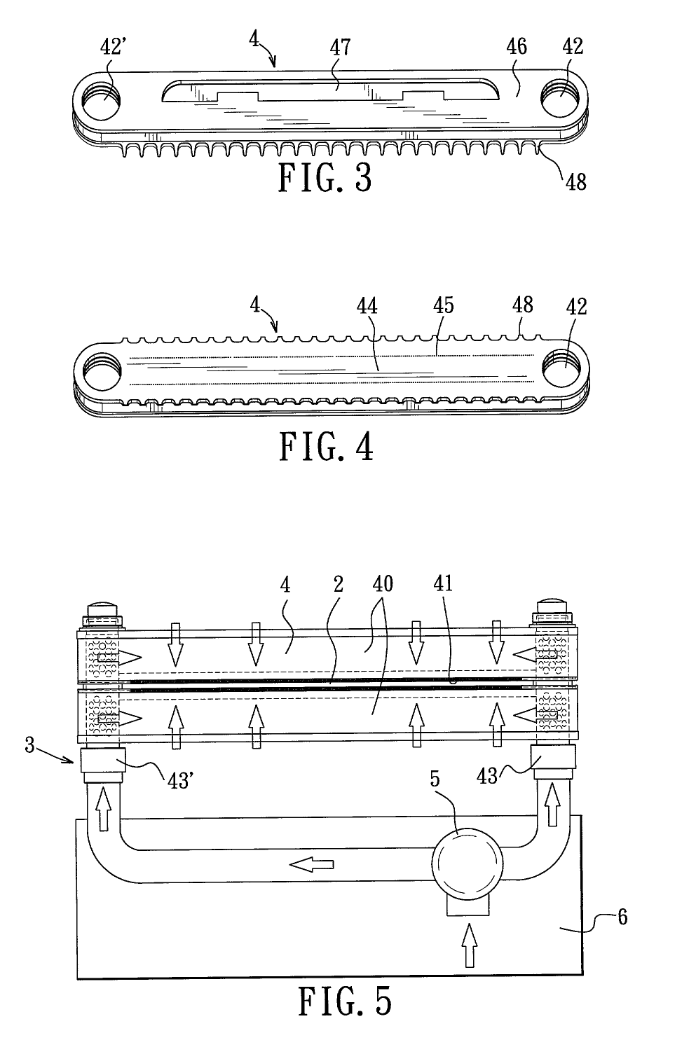

The casings 4, 4′ are located directly over, and are fixed relative to the tank 6. The lower spraying casings 4′ are disposed under the upper spraying casings 4. Each of the casings 4, 4′ has a chamber 40, and an inlet unit consisting of two inlets 42, 42′ (see FIGS. 3 and 4) that are formed in two ends thereof and that are in fluid communication with the chamber 40. A detergent is contained within the tank 6, and is forced by the pump 5 to the inlets 42, 42′ in the casings 4, 4′ via a conduit unit, which includes a plurality of conduits 43, 43′ (see FIG. 5). Additional detergent will be supplemented automatically into the tank 6 as soon as the detergent level in the tank 6 is lowered to a predetermined level. The roller unit 7 is disposed outwardly of the casings 4, 4′, and is adapted to move a horizontal circuit board 2 between the casings 4 and 4′ in a transverse direction of the casings 4, 4′, which is indicated by an arrowhead (A) in FIG. 2.

Referring to FIGS. 2, 3, 4, and 5, each of the upper spraying casings 4 has a horizontal top surface 46 that is formed with an integral handle 47, and a horizontal bottom wall 44 that is formed with two longitudinal rows of closely spaced spraying holes 45, and two rows of guiding teeth 48 extending integrally, transversely and outwardly from two opposite longitudinal sides thereof. The lower spraying casings 4′ are symmetrical relative to the upper spraying casings 4. That is to say, each of the lower spraying casings 4′ has a horizontal bottom surface with a handle (not shown), and a horizontal top wall with two longitudinal rows of holes (not shown) and two rows of guiding teeth 48′.

In each of the washing units 3, the casings 4, 4′ define a washing space 41 therebetween for passage of the board 2. The spaces 41 are slightly wider than the board 2.

Each of the guiding teeth 48, 48′ of the upper and lower spraying casings 4, 4′ has an outwardly and upwardly inclined guiding face 481, 481′ (see FIG. 2). Accordingly, the board 2 can be guided into the washing spaces 41. Furthermore, the detergent can be guided to fall from the lower spraying casings 4′ via the guiding faces 481′.

According to Bernoulli's theorem, each of the holes 45 has a constant detergent flow rate. As such, the detergent can be distributed evenly onto the board 2, thereby minimizing detergent residue on the same.

With this invention thus explained, it is apparent that numerous modifications and variations can be made without departing the scope and spirit of this invention. It is therefore intended that this invention be limited only as indicated by the appended claims.

I claim:

1. A circuit board-washing device comprising:
a tank adapted to contain a detergent;
a pair of elongated upper and lower spraying casings located directly over and fixed relative to said tank, each of said upper and lower spraying casings having a chamber and an inlet unit that is in fluid communication with said chamber, said upper spraying casing including a horizontal bottom wall which is formed with two longitudinal rows of closely spaced spraying holes therethrough that are in fluid communication with said chamber in said upper spraying casing, said lower spraying casing being disposed under said upper spraying casing and having a horizontal top wall which is formed with two longitudinal rows of closely spaced spraying holes therethrough that are in fluid communication with said chamber in said lower spraying casing and that are aligned with said spraying holes in said upper spraying casings, said bottom wall of said upper spraying casing and said top wall of said lower spraying casing defining a washing space therebetween, which is adapted to permit passage of a horizontal circuit board to be washed in a transverse direction of said upper and lower spraying casings and which is slightly wider than the circuit board;
a conveying roller unit disposed outwardly of said upper and lower spraying casings and adapted to move the circuit board through said washing space;
a conduit unit in fluid communication with said inlet units in said upper and lower spraying casings and said tank; and
a pump unit adapted to force the detergent in said tank to said upper and lower spraying casings via said conduit unit.

2. The circuit board-washing device as claimed in claim 1, wherein said upper spraying casing has atop surface, said lower spraying casing having a bottom surface, each of said top and bottom surfaces being formed with an integral handle.

3. The circuit board-washing device as claimed in claim 1, wherein each of said bottom wall of said upper spraying casing and said top wall of said lower spraying casing has two opposite longitudinal sides, each of which is formed with a row of guiding teeth that extend integrally, transversely and outwardly therefrom, each of said guiding teeth of said upper and lower spraying casings having an outwardly and upwardly inclined guiding face so as to be adapted to guide the circuit board into said washing space and so as to be adapted to guide the detergent to fall from said lower spraying casing via said guiding faces of said lower spraying casing.

4. The circuit board-washing device as claimed in claim 1, wherein each of said upper and lower spraying casings includes two inlets, which are formed respectively in two ends thereof and which constitute a respective one of said inlet units.
